(19) United States
(12) Patent Application Publication
(10) Pub. No.: US 2025/0356671 A1
(43) Pub. Date: Nov. 20, 2025

(54) PERSONALIZED OPEN-VOCABULARY SEMANTIC SEGMENTATION FOR IMAGES

(71) Applicant: QUALCOMM Incorporated, San Diego, CA (US)

(72) Inventors: Sunghyun PARK, Seoul (KR); Jungsoo LEE, Paju (KR); Shubhankar Mangesh BORSE, San Diego, CA (US); Munawar HAYAT, San Diego, CA (US); Kyu Woong HWANG, Daejeon (KR); Fatih Murat PORIKLI, San Diego, CA (US); Sungha CHOI, Goyang-si (KR)

(21) Appl. No.: 18/883,762

(22) Filed: Sep. 12, 2024

Related U.S. Application Data
(60) Provisional application No. 63/647,841, filed on May 15, 2024.

(51) Int. Cl. G06V 20/70; G06F 40/35; G06V 10/26; G06V 10/764; G06V 10/776; G06V 10/82

(52) U.S. Cl. CPC G06V 20/70; G06F 40/35; G06V 10/26; G06V 10/764; G06V 10/776; G06V 10/82

(57) ABSTRACT

Disclosed are systems and techniques for image processing. For example, a computing device can process, using an encoder, an image to generate a feature map representing the image. The computing device can use the encoder to determine, based on the feature map, mask embeddings, negative mask embeddings, textual embeddings, and textual prompts for semantic segmentation of the image. The computing device can use a semantic segmentation model to determine, based on the feature map, mask proposals and a negative mask for the image and to determine a similarity map between total mask embeddings (including the mask embeddings and the negative mask embeddings) and total textual embeddings (including the textual embeddings and the textual prompts). The computing device can determine, using the semantic segmentation model, final semantic predictions for the image based on the similarity map and total mask proposals (including the mask proposals and the negative mask).

### CROSS-REFERENCE TO RELATED APPLICATION

This application claims the benefit of, and priority to, U.S. Provisional Application No. 63/647,841, filed May 15, 2024, which is hereby incorporated by reference, in its entirety and for all purposes.

### FIELD

The present disclosure generally relates to image processing. For example, aspects of the present disclosure relate to personalized open-vocabulary semantic segmentation for images.

### BACKGROUND

The increasing versatility of digital camera products has allowed digital cameras to be integrated into a wide array of devices and has expanded their use to different applications. For example, extended reality (XR) devices, phones, drones, cars, computers, televisions, and many other devices today are often equipped with camera devices. The camera devices allow users to capture images and/or video (e.g., including frames of images) from any system equipped with a camera device. The images and/or videos can be captured for recreational use, professional photography, surveillance, and automation, among other applications. Moreover, camera devices are increasingly equipped with specific functionalities for modifying images or creating artistic effects on the images. For example, some camera devices are equipped with image processing capabilities for generating semantic labels for objects in captured images.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, apparatuses, methods and computer-readable media for personalized open-vocabulary semantic segmentation for images. According to at least one example, an apparatus for image processing is provided. The apparatus includes at least one memory and at least one processor coupled to the at least one memory and configured to: process, using an encoder of a machine learning system, an image to generate a feature map representing the image; determine, using the encoder based on the feature map, mask embeddings, negative mask embeddings, textual embeddings, and textual prompts for semantic segmentation of the image; determine, using a semantic segmentation model, mask proposals and a negative mask for the image based on the feature map; determine, using the semantic segmentation model, a similarity map between total mask embeddings and total textual embeddings, wherein the total mask embeddings include the mask embeddings and the negative mask embeddings, and wherein the total textual embeddings include the textual embeddings and the textual prompts; and determine, using the semantic segmentation model, final semantic predictions for the image based on the similarity map and total mask proposals, wherein the total mask proposals include the mask proposals and the negative mask.

In some aspects, a method of image processing is provided. The method includes: processing, by an encoder of a machine learning system, an image to generate a feature map representing the image; determining, by the encoder based on the feature map, mask embeddings, negative mask embeddings, textual embeddings, and textual prompts for semantic segmentation of the image; determining, by a semantic segmentation model, mask proposals and a negative mask for the image based on the feature map; determining, by the semantic segmentation model, a similarity map between total mask embeddings and total textual embeddings, wherein the total mask embeddings include the mask embeddings and the negative mask embeddings, and wherein the total textual embeddings include the textual embeddings and the textual prompts; and determining, by the semantic segmentation model, final semantic predictions for the image based on the similarity map and total mask proposals, wherein the total mask proposals include the mask proposals and the negative mask.

In some aspects, a non-transitory computer-readable medium is provided having stored thereon instructions that, when executed by one or more processors, cause the one or more processors to: process, using an encoder of a machine learning system, an image to generate a feature map representing the image; determine, using the encoder based on the feature map, mask embeddings, negative mask embeddings, textual embeddings, and textual prompts for semantic segmentation of the image; determine, using a semantic segmentation model, mask proposals and a negative mask for the image based on the feature map; determine, using the semantic segmentation model, a similarity map between total mask embeddings and total textual embeddings, wherein the total mask embeddings include the mask embeddings and the negative mask embeddings, and wherein the total textual embeddings include the textual embeddings and the textual prompts; and determine, using the semantic segmentation model, final semantic predictions for the image based on the similarity map and total mask proposals, wherein the total mask proposals include the mask proposals and the negative mask.

In some aspects, an apparatus of image processing is provided. The apparatus includes: means for processing an image to generate a feature map representing the image; means for determining, based on the feature map, mask embeddings, negative mask embeddings, textual embeddings, and textual prompts for semantic segmentation of the image; means for determining mask proposals and a negative mask for the image based on the feature map; means for determining a similarity map between total mask embeddings and total textual embeddings, wherein the total mask embeddings includes the mask embeddings and the negative mask embeddings, and wherein the total textual embeddings include the textual embeddings and the textual prompts; and means for determining final semantic predictions for the image based on the similarity map and total mask proposals, wherein the total mask proposals include the mask proposals and the negative mask.

Aspects generally include a method, apparatus, system, computer program product, non-transitory computer-readable medium, user device, user equipment, wireless communication device, and/or processing system as substantially described with reference to and as illustrated by the drawings and specification.

In some aspects, each of the apparatuses described above is, can be part of, or can include a mobile device, a smart or connected device, a camera system, and/or an extended reality (XR) device (e.g., a virtual reality (VR) device, an augmented reality (AR) device, or a mixed reality (MR) device). In some examples, the apparatuses can include or be part of a vehicle, a mobile device (e.g., a mobile telephone or so-called “smart phone” or other mobile device), a wearable device, a personal computer, a laptop computer, a tablet computer, a server computer, a robotics device or system, an aviation system, or other device. In some aspects, the apparatus includes an image sensor (e.g., a camera) or multiple image sensors (e.g., multiple cameras) for capturing one or more images. In some aspects, the apparatus includes one or more displays for displaying one or more images, notifications, and/or other displayable data. In some aspects, the apparatus includes one or more speakers, one or more light-emitting devices, and/or one or more microphones. In some aspects, the apparatuses described above can include one or more sensors. In some cases, the one or more sensors can be used for determining a location of the apparatuses, a state of the apparatuses (e.g., a tracking state, an operating state, a temperature, a humidity level, and/or other state), and/or for other purposes.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a block diagram of an example transformer, in accordance with some aspects of the disclosure.

FIG. 2 is a diagram illustrating examples of different methods for semantic segmentation for images, in accordance with some aspects of the disclosure.

FIG. 3 is a diagram illustrating a comparison of open-vocabulary semantic segmentation with personalized open-vocabulary semantic segmentation, in accordance with some aspects of the disclosure.

FIG. 4 is a diagram illustrating examples of different use cases for personalized open-vocabulary semantic segmentation, in accordance with some aspects of the disclosure.

FIG. 5A is a diagram illustrating an example of a personalized open-vocabulary semantic segmentation system, in accordance with some aspects of the disclosure.

FIG. 5B is a diagram illustrating of an open-vocabulary semantic segmentation engine, in accordance with some aspects of the disclosure.

FIG. 6 is a diagram illustrating examples of a personalized open-vocabulary semantic segmentation engine 610, in accordance with some aspects of the disclosure.

FIG. 7 is a diagram illustrating an example of a process of using an additional visual embedding for tuning textual prompts, in accordance with some aspects of the disclosure.

FIG. 8 is a diagram illustrating an example of determining a segmentation mask that may be utilized as a ground truth for evaluation, in accordance with some aspects of the disclosure.

FIG. 9 is a flow diagram illustrating an example of a process for personalized open-vocabulary semantic segmentation for images, in accordance with some aspects of the disclosure.

FIG. 10 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

A camera is a device that receives light and captures image frames, such as still images or video frames, using an image sensor. Cameras may include one or more processors, such as image signal processors (ISPs), that can process one or more image frames captured by an image sensor. For example, a raw image frame captured by an image sensor can be processed by an image signal processor (ISP) to generate a final image. Cameras can be configured with a variety of image capture and image processing settings to alter the appearance of an image.

The increasing versatility of digital camera products has allowed digital cameras to be integrated into a wide array of devices and has expanded their use to different applications. For example, extended reality (XR) devices, phones, drones, cars, computers, televisions, and many other devices today are often equipped with camera devices. The camera devices allow users to capture images and/or video (e.g., including frames of images) from any system equipped with a camera device. The images and/or videos can be captured for recreational use, professional photography, surveillance, and automation, among other applications. Moreover, camera devices are increasingly equipped with specific functionalities for modifying images or creating artistic effects on the images. For example, some camera devices are equipped with image processing capabilities for generating semantic labels for objects in captured images.

Semantic segmentation is a computer vision task that assigns a class label to pixels within an image by using a machine learning algorithm. Semantic segmentation tasks help machines to distinguish between different object classes and background regions within an image. Semantic segmentation of images (along with the creation of semantic maps) plays in important role in training computers to recognize important context in digital images, such as landscapes, people, medical images, and more.

Open-vocabulary semantic segmentation is the task of performing semantic segmentation with unknown classes. Open-vocabulary semantic segmentation aims to segment an image into semantic regions according to textual descriptions (e.g., unknown classes), which may have not been seen during training of the machine learning algorithm. Recently, two-stage methods are used that first generate class-agnostic mask proposals and, then, leverage pre-trained vision models, such as the contrastive language-image pre-training (CLIP) model, to classify masked regions.

Due to the recent developments of large-scale vision-language models (e.g., CLIP), open-vocabulary semantic segmentation has recently shown large improvements. Unlike traditional semantic segmentation, which is limited to making segmentation predictions within a fixed set of categories, open-vocabulary semantic segmentation enables the segmentation of regions with arbitrary classes, which are not used during the training phase. Such models are crucial for deploying semantic segmentation models in real-world applications since novel categories may be encountered that were not seen during the training of the models. Despite previous studies in open-vocabulary semantic segmentation, segmenting a region that a user is interested in using unseen categories has been underexplored. For example, finding “my favorite tumbler” among a number of tumblers can be challenging for existing open-vocabulary semantic segmentation methods, which can often produce false positive predictions. Although there exists another group of methods which focuses on few-shot semantic segmentation. These methods are designed for only a closed-set semantic segmentation, which can limit their applicability in the real world. As such, improved systems and techniques for personalized open-vocabulary semantic segmentation for images can be beneficial.

In one or more aspects, systems, apparatuses, processes (also referred to as methods), and computer-readable media (collectively referred to herein as “systems and techniques”) are described herein for providing personalized open-vocabulary semantic segmentation for images. In one or more examples, the systems and techniques provide a personalized open-vocabulary semantic segmentation that segments images into regions determined to be of interest to a user, while maintaining the performance of original open-vocabulary semantic segmentation methods.

In one or more aspects, the disclosed personalized open-vocabulary semantic segmentation employs a negative mask proposal, which focuses on learning regions other than a personalized concept (e.g., regions that are not of interest to a user). While a given pretrained open-vocabulary semantic segmentation model, such as a side adaptor network (SAN), can capture the personalized concept well, the given pretrained open-vocabulary semantic segmentation model can over-confidently erroneously predict other regions as the personalized concept. By adding a negative mask that recognizes visual concepts other than the personalized concept, the disclosed personalized open-vocabulary semantic segmentation can produce more accurate predictions. In one or more examples, the systems and techniques can improve the performance of the disclosed personalized open-vocabulary semantic segmentation by additionally injecting visual embeddings extracted from a pre-trained image encoder (e.g., CLIP or other image encoder) to the textual prompt embeddings.

In one or more aspects, the disclosed personalized open-vocabulary semantic segmentation segments personalized visual concepts included within one or more pairs of images and masks. The personalized open-vocabulary semantic segmentation allows for a reduction in false positive predictions by employing text prompt tuning via negative mask proposals. The personalized open-vocabulary semantic segmentation can also enrich the semantic representation by adding visual embeddings from a pretrained image encoder (e.g., CLIP). The disclosed personalized open-vocabulary semantic segmentation has improved performance as compared to existing personalized open-vocabulary semantic segmentation methods using established semantic segmentation data sets, such as few-shot segmentation (FSS)-1000, Caltech-UCSD Birds (CUB)-200, and ADE-20K.

In one or more aspects, during operation of the systems and techniques for personalized open-vocabulary semantic segmentation for images, an encoder of a machine learning system can process an image to generate a feature map representing the image. The encoder, based on the feature map, can determine mask embeddings, negative mask embeddings, textual embeddings, and textual prompts for semantic segmentation of the image. A semantic segmentation model can determine mask proposals and a negative mask for the image based on the feature map. The semantic segmentation model can determine a similarity map between total mask embeddings and total textual embeddings. In one or more examples, the total mask embeddings can include the mask embeddings and the negative mask embeddings. In some examples, the total textual embeddings can include the textual embeddings and the textual prompts. The semantic segmentation model can determine final semantic predictions for the image based on the similarity map and total mask proposals. In one or more examples, the total mask proposals can include the mask proposals and the negative mask.

In one or more examples, the encoder can perform textual prompt tuning to train the textual prompts based on personal concepts for the image. In some examples, determining the textual prompts can be based on an additional visual embedding. In one or more examples, determining the textual prompts can be further based on a combination of the additional visual embedding and an average of the textual embeddings. In some examples, the combination can include a convex sum of the additional visual embedding with an average of the textual embeddings.

In some examples, determining the negative mask embeddings can include learning vocabulary other than personal concepts. In one or more examples, determining the negative mask can include learning visual concepts other than personal visual concepts. In some examples, the final semantic predictions can be evaluated based on one or more pairs of object class images. In one or more examples, each pair of object class images can include a positive image associated with an object class and a negative image associated with the object class.

In one or more examples, the encoder can be a pre-trained neural network image encoder. In some examples, the pre-trained neural network image encoder can be a contrastive language-image pre-training (CLIP) model. In one or more examples, the semantic segmentation model can be a pre-trained open-vocabulary semantic segmentation neural network model. In some examples, the pre-trained open-vocabulary semantic segmentation neural network model can be a side adapter network (SAN). In one or more examples, each textual embedding of the textual embeddings can include a vector that represents a textual label associated with an object class. In some examples, each mask embedding of the mask embeddings can include a vector that represents a visual image associated with an object class. In one or more examples, each negative mask embedding of the negative mask embeddings can include a vector that represents a visual image not associated with an object class. In some examples, each textual prompt of the textual prompts can represent a textual label associated with a personalized object class.

Additional aspects of the present disclosure are described in more detail below.

Machine learning (ML) can be considered a subset of artificial intelligence (AI). ML systems can include algorithms and statistical models that computer systems can use to perform various tasks by relying on patterns and inference, without the use of explicit instructions. One example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others. Different types of neural networks exist, such as convolutional neural networks (CNNs), recurrent neural networks (RNNs), generative adversarial networks (GANs), multilayer perceptron (MLP) neural networks, transformer neural networks, among others.

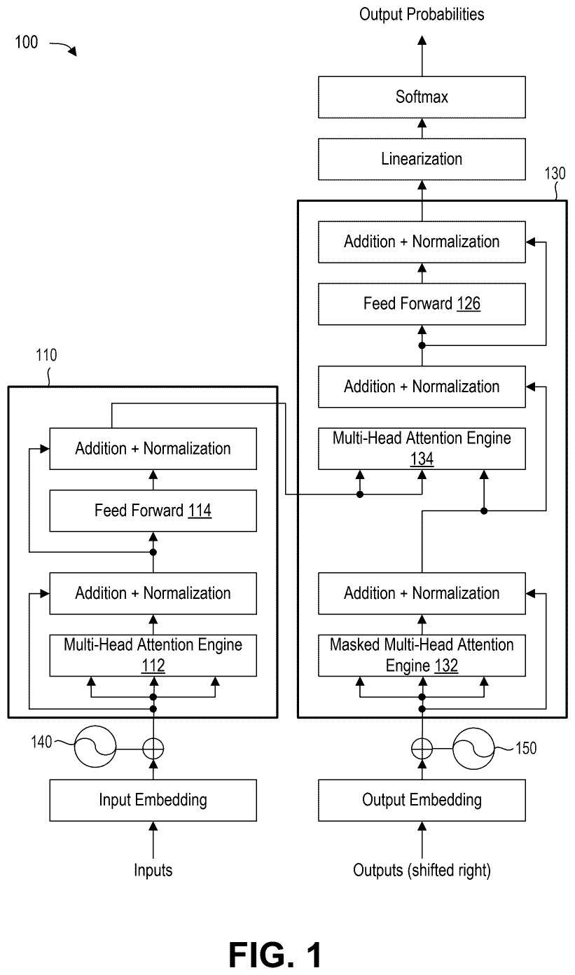

FIG. 1 is a block diagram of an example transformer. In a convolutional neural network (CNN) model, the number of operations required to relate signals from two arbitrary input or output positions grows in the distance between positions, which makes learning dependencies at different distant positions challenging for a CNN model. A transformer 100 reduces the operations of learning dependencies by using an encoder 110 and a decoder 130 that implement an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 110 is composed of a stack of six identical layers and each layer has two sub-layers. The first sub-layer is a multi-head self-attention engine 112, and the second sub-layer is a fully connected feed-forward network 114. A residual connection (not shown) connects around each of the sub-layers followed by normalization.

In the example transformer 100, the decoder 130 is also composed of a stack of six (6) identical layers. The decoder also includes a masked multi-head self-attention engine 132, a multi-head attention engine 134 over the output of the encoder 110, and a fully connected feed-forward network 126. Each layer includes a residual connection (not shown) around the layer, which is followed by layer normalization. The masked multi-head self-attention engine 132 is masked to prevent positions from attending to subsequent positions and ensures that the predictions at position i can depend only on the known outputs at positions less than i (e.g., auto-regression).

In the transformer, the queries, keys, and values are linearly projected by a multi-head attention engine into learned linear projects, and then attention is performed in parallel on each of the learned linear projects, which are concatenated and then projected into final values.

The transformer also includes a positional encoder 140 to encode positions because the model does not contain recurrence and convolution and relative or absolute position of the tokens is needed. In the transformer 100, the positional encodings are added to the input embeddings at the bottom layer of the encoder 110 and the decoder 130. The positional encodings are summed with the embeddings because the positional encodings and embeddings have the same dimensions. A corresponding position decoder 150 is configured to decode the positions of the embeddings for the decoder 130.

In some aspects, the transformer 100 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 100 can process input sequences of variable length, making the transformer 100 well-suited for natural language processing tasks where input lengths can vary greatly. Additionally, the self-attention mechanism allows the transformer 100 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

As previously mentioned, semantic segmentation is a computer vision task that assigns a class label to pixels within an image by using a machine learning algorithm. Semantic segmentation tasks assist machines to distinguish between different object classes and background regions within an image. Semantic segmentation of images (along with the creation of semantic maps) is used to train computers to recognize important context in digital images, such as landscapes, people, medical images, and more.

As noted above, open-vocabulary semantic segmentation performs semantic segmentation with unknown classes. Open-vocabulary semantic segmentation aims to segment an image into semantic regions according to textual descriptions (e.g., unknown classes), which may have not been seen during training of the machine learning algorithm. Two-stage methods (e.g., side adaptor network (SAN), open-vocabulary diffusion-based panoptic segmentation (ODISE), and panoptic open-vocabular segment anything model (PosSAM)) have been recently used that first generate class-agnostic mask proposals and, then, leverage pre-trained vision foundation models (e.g., contrastive language-image pre-training (CLIP) model, stable diffusion, and the segment anything model (SAM)) to classify masked regions (e.g., for the open-vocabulary semantic segmentation task). These open-vocabulary semantic segmentation models (e.g., SAN and ODISE) have been adapted to understand a user's personal expressions (e.g., “my cup”), not just generic terms (e.g., “cup”)

Large-scale vision-language models (e.g., CLIP) have led to improvements in open-vocabulary semantic segmentation. Unlike traditional semantic segmentation that is limited to making segmentation predictions within a fixed set of categories, open-vocabulary semantic segmentation enables the segmentation of regions with arbitrary classes that are not used during the training phase. Such models are crucial for deploying semantic segmentation models in real-world applications since novel categories may be encountered that were not seen during the training of the models. Despite previous studies in open-vocabulary semantic segmentation, segmenting a region that a user is interested in using unseen categories has been underexplored. For example, finding “my favorite cup” among a number of cup can be challenging for existing open-vocabulary semantic segmentation methods that often produce false positive predictions. Although there exists another group of methods which focuses on few-shot semantic segmentation. These methods are designed for only a closed-set semantic segmentation, which can limit their applicability in the real world.

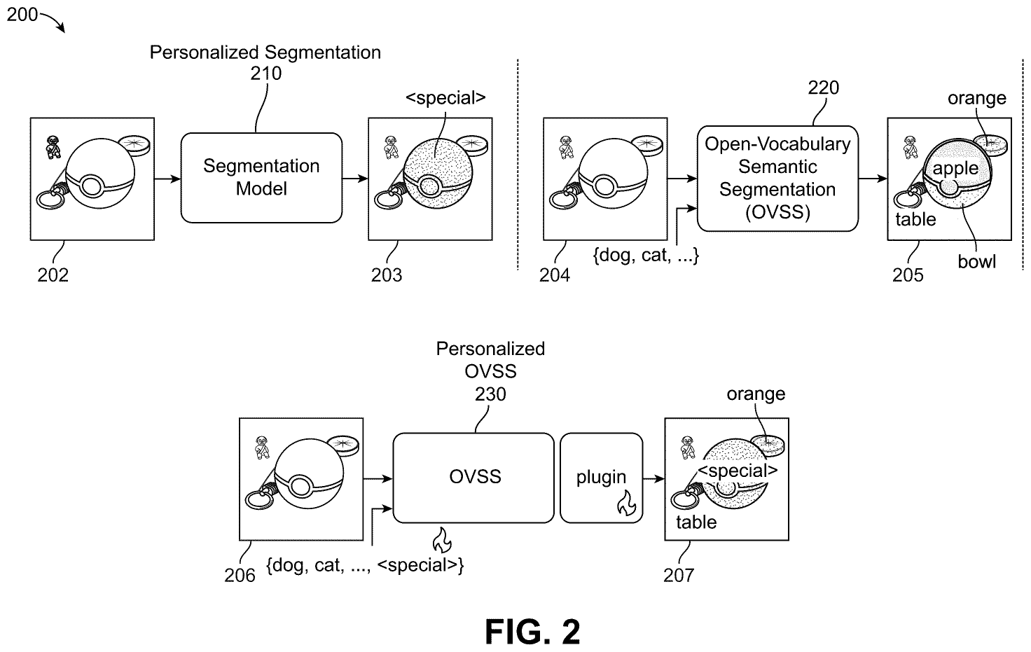

FIG. 2 is a diagram illustrating examples 200 of different methods 210, 220, 230 for semantic segmentation for images. As shown in FIG. 2, method 210 is for personalized segmentation, method 220 is for open-vocabulary semantic segmentation (OVSS), and method 230 is for the disclosed open-vocabulary semantic segmentation, which utilizes a combination of OVSS and a plugin (e.g., the additional of a negative mask).

The method 210 shows a segmentation model producing a segmentation map 203 from an input image 202 (e.g., including a red pokeball). The produced segmentation map 203 from the method 210 labels the ball with a generic semantic label. The method 210 is not capable of personalized semantic segmentation. The method 220 in FIG. 2 shows an OVSS model producing a segmentation map 205 from an input image 204 (e.g., including a red pokeball). The produced segmentation map 205 from the method 220 labels the ball with multiple personalized semantic labels, including “table,” “apple,” “bowl,” and “orange.” In FIG. 2, the method 230 shows the disclosed model producing a segmentation map 207 from an input image 206 (e.g., including a red pokeball). The produced segmentation map 207 from the method 230 labels the ball with a generic semantic label (shown as “dog” and “cat”) and a personalized label (shown as “<special>”). Existing semantic segmentation methods only recognize personalized feature concepts using a few images and a few masks of the object class.

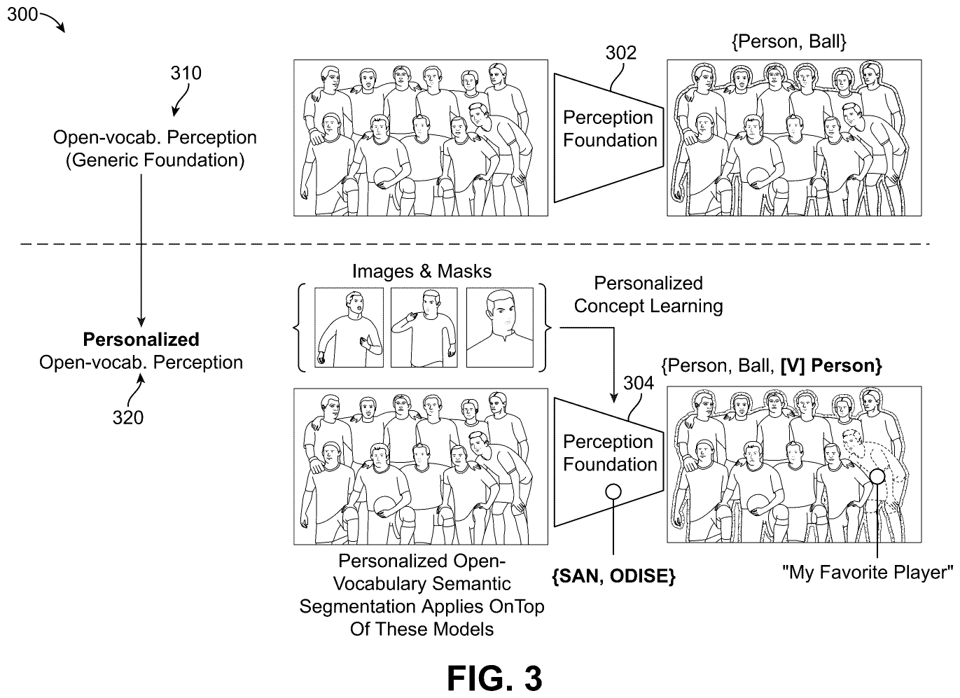

FIG. 3 is a diagram illustrating a comparison 300 of open-vocabulary semantic segmentation 310 (e.g., open-vocabulary perception) with personalized open-vocabulary semantic segmentation 320 (e.g., personalized open-vocabulary perception). In FIG. 3, for the open-vocabulary semantic segmentation 310, a perception foundation model 302 is trained to recognize open vocabulary, such as a “person” and a “ball,” by using a number of images and masks (e.g., three, four, ten, or other number of images and masks).

For the personalized open-vocabulary semantic segmentation 320, a perception foundation model 304 (e.g., SAN or OSIDE) is trained to recognize open vocabulary, such as a “person” and a “ball,” by using a number of images and masks (e.g., three, four, ten, or other number of images and masks). The perception foundation model 304 (e.g., SAN or OSIDE) is also trained for personalized concept learning to recognize personalized vocabulary, such as “my favorite player,” using the images and masks.

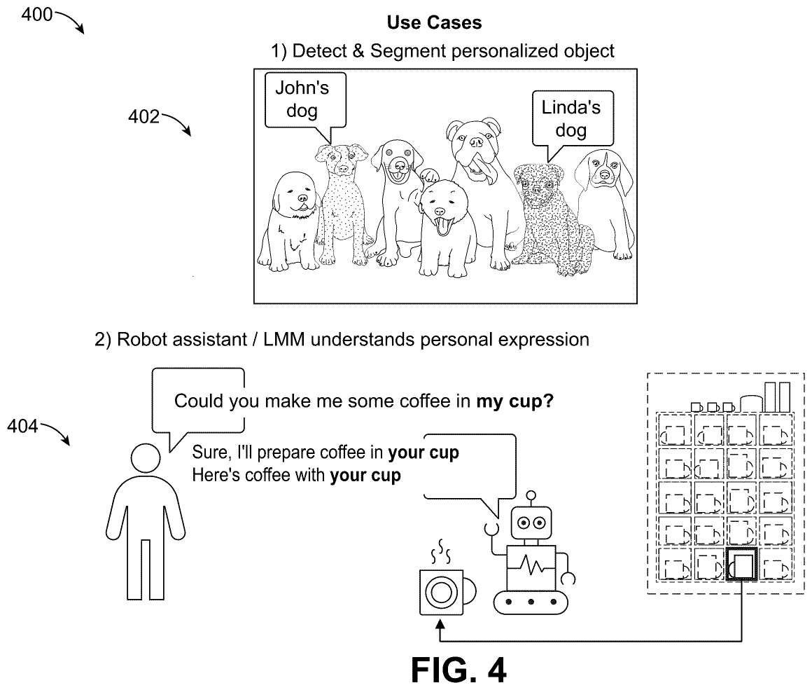

Personalized open-vocabulary semantic segmentation may be employed for various different use cases. FIG. 4 is a diagram illustrating examples of different use cases 400 for personalized open-vocabulary semantic segmentation. In FIG. 4, a first use case 402 is shown where, for personalized open-vocabulary semantic segmentation, a perception foundation model (e.g., SAN or OSIDE) is trained for personalized concept learning to detect and recognize personalized objects, including “John's dog” and “Linda's dog,” using a number of images and masks (e.g., three, four, ten, or other number of images and masks).

In FIG. 4, a second use case 404 is shown where a large language model (LLM), such as implemented within a robot assistant, is trained for visual question answering (VQA) to understand personal expressions, such as “my cup” and “your cup.” In the use case 404 of FIG. 4, a user is shown to ask the robot assistant to make coffee in “my cup.”

As previously mentioned, the systems and techniques described herein can use a two-stage process (e.g., SAN, ODISE, PosSAM) that can first generate class-agnostic mask proposals and can then leverage pre-trained vision foundation models (e.g., CLIP, stable diffusion, and SAM) to classify masked regions (e.g., for open-vocabulary semantic segmentation).

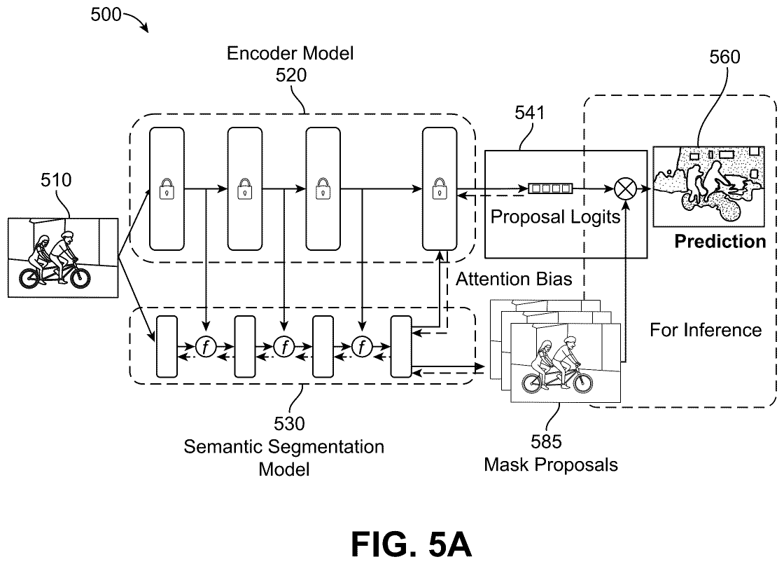

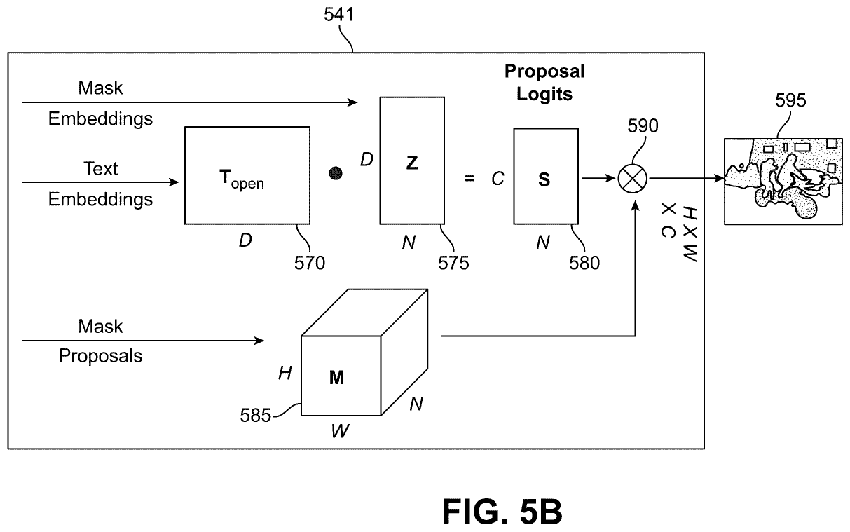

FIG. 5A is a diagram illustrating an example system 500 for personalized open-vocabulary semantic segmentation. The system 500 includes an encoder model 520, a semantic segmentation model 530, and an open-vocabulary semantic segmentation engine 541 are shown. FIG. 5B is a diagram illustrating an example of the open-vocabulary semantic segmentation engine 541. In some aspects, the encoder model can include a CLIP mode and the semantic segmentation model can include a SAN model. For example, in FIG. 5A, the semantic segmentation model 530 (or other a lightweight vision transformer) is used for open-vocabulary semantic segmentation. In FIG. 5A, the semantic segmentation 530 can leverage the features from the encoder model 520 to generate a final semantic map 595.

During operation of the system 500, the encoder model 520 (e.g., the CLIP model) can process an image 510 to generate a feature map (or multiple feature maps) representing the image 510. In one or more examples, the encoder model 520 can be a pre-trained neural network image encoder. In some examples, the pre-trained neural network image encoder can be a CLIP model.

The encoder model 520 (e.g., the CLIP model), based on the feature map, can determine mask embeddings (Z) 575 and textual embeddings (Tₒₚₑₙ) 570 (as shown in FIG. 5B) for semantic segmentation of the image 510. In FIG. 5B, the letter “D” denotes the number of channels of the textual embeddings (Tₒₚₑₙ) 570 and the mask embeddings (Z) 575. The letter “C” denotes the number of classes or number of vocabulary words for textual prompts within the textual embeddings (Tₒₚₑₙ) 570.

In aspects, each textual embedding of the textual embeddings (Tₒₚₑₙ) 570 can include a vector that represents a textual label associated with an object class. In some cases, each mask embedding of the mask embeddings (Z) 575 can include a vector that represents a visual image associated with an object class. In some examples, each textual prompt of the textual prompts can represent a textual label associated with a personalized object class.

The semantic segmentation model 530 (e.g., the SAN model) can determine mask proposals (M) 585 for the image 510 based on the feature map(s) generated by the encoder model 520. In some aspects, the semantic segmentation model 530 can be a pre-trained open-vocabulary semantic segmentation neural network model. In some examples, the pre-trained open-vocabulary semantic segmentation neural network model can be a SAN model. In FIG. 5B, the letter “N” denotes the number of masks in the mask proposals (M) 585. The letters “H” and “W” denote the height and width of a matrix of the mask proposals (M) 585, respectively.

The semantic segmentation model 530 (e.g., the SAN) can determine (e.g., compute) a similarity map (S) 580 between the mask embeddings (Z) 575 and the textual embeddings (Tₒₚₑₙ) 570. The semantic segmentation model 530 (e.g., the SAN) can determine (e.g., calculate) the final semantic map 560 with final semantic predictions for the image based on the similarity map (S) 580 and the mask proposals (M) 585. For instance, the semantic segmentation model 530 can multiply (e.g., using a multiplier 590) the similarity map (S) 580 with the mask proposals (M) 585 to generate the final semantic map 560.

In some cases, the system 500 can have difficulty segmenting a region that a user is interested in using unseen categories and, as such, the system 500 can frequently produce false positive predictions. In such cases, the systems and techniques described herein for personalized open-vocabulary semantic segmentation for images can be useful. For example according to one or more aspects, the systems and techniques provide personalized open-vocabulary semantic segmentation for images. In one or more examples, the systems and techniques provide a personalized open-vocabulary semantic segmentation that segments regions of a user's interest, while maintaining the performance of original open-vocabulary semantic segmentation methods.

In one or more aspects, the disclosed personalized open-vocabulary semantic segmentation utilizes a negative mask proposal that focuses on learning regions other than a personalized concept. While a given pretrained open-vocabulary semantic segmentation model (e.g., SAN) can capture the personalized concept well, the model may over-confidently erroneously predict other regions as the personalized concept. By adding a negative mask that recognizes visual concepts other than the personalized concept, the disclosed personalized open-vocabulary semantic segmentation can produce more accurate predictions. In one or more examples, the systems and techniques can improve the performance of the disclosed personalized open-vocabulary semantic segmentation by injecting visual embeddings extracted from a pre-trained image encoder (e.g., CLIP) to the textual prompt embeddings.

In one or more aspects, the disclosed personalized open-vocabulary semantic segmentation segments personalized visual concepts included within one or more pairs of images and masks. The disclosed personalized open-vocabulary semantic segmentation can allow for a reduction in false positive predictions by employing text prompt tuning via negative mask proposals, and can enrich the semantic representation by adding visual embeddings from a pretrained image encoder (e.g., CLIP). The prompt tuning, which improves recall (e.g., recognizing a personalized concept), can be performed as a straightforward approach for learning a new personalized concept. The disclosed personalized open-vocabulary semantic segmentation has improved performance as compared to existing personalized open-vocabulary semantic segmentation methods utilizing established semantic segmentation data sets (e.g., FSS-1000, CUB-200, and ADE-20K).

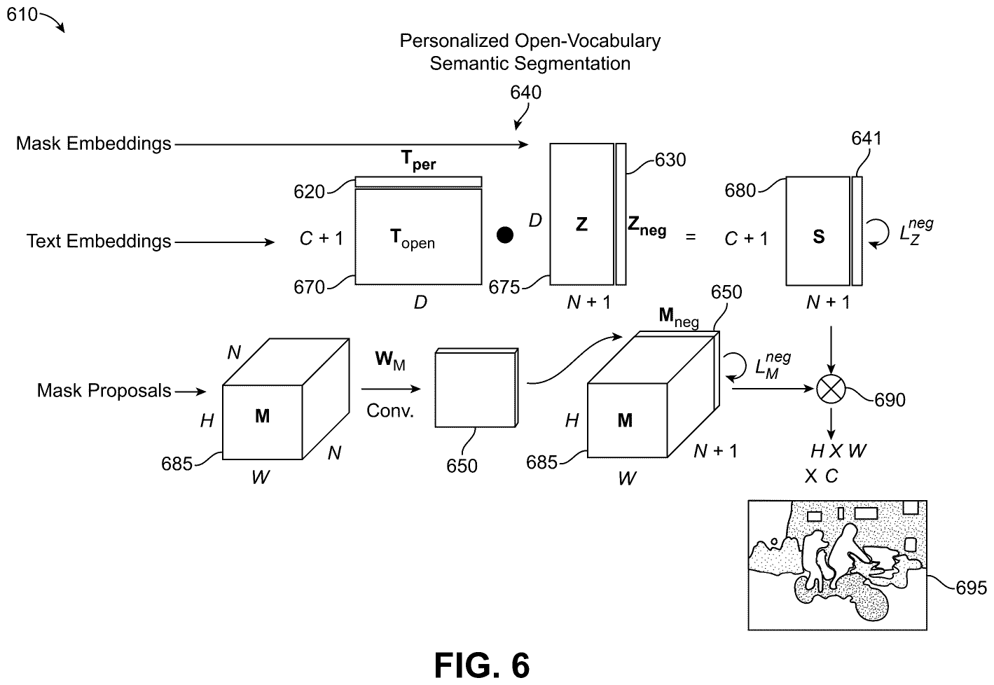

FIG. 6 is a diagram illustrating an example of an open-vocabulary semantic segmentation engine 610. According to some aspects, the open-vocabulary semantic segmentation engine 610 can be used in the system 500 of FIG. 5A to replace the open-vocabulary semantic segmentation engine 541 of FIG. 5A and FIG. 5B. The open-vocabulary semantic segmentation engine 610 utilizes negative mask embeddings and negative masks to reduce the number of false positive predictions (e.g., as compared to the open-vocabulary semantic segmentation engine 541 of FIG. 5A and FIG. 5B). For instance, the open-vocabulary semantic segmentation engine 610 can employ the use of negative mask embeddings (Z_{neg}) 630 and a negative mask (M_{neg}) 650.

During operation of the open-vocabulary semantic segmentation engine 610, an encoder (e.g., CLIP) of a machine learning system (e.g., the encoder model 520 of FIG. 5A) may process an image to generate one or more feature maps representing the image. In one or more examples, the encoder may be a pre-trained neural network image encoder. In some examples, the pre-trained neural network image encoder may be a CLIP model.

The encoder (e.g., CLIP), based on the feature map, may determine mask embeddings (Z) 675, negative mask embeddings (Z_{neg}) 630, textual embeddings (Tₒₚₑₙ) 670, and textual prompts (Tₚₑᵣ) 620 for semantic segmentation of the image. In one or more examples, each textual embedding of the textual embeddings (Tₒₚₑₙ) 670 may include a vector that represents a textual label associated with an object class. In some examples, each mask embedding of the mask embeddings (Z) 675 may include a vector that represents a visual image associated with an object class. In one or more examples, each negative mask embedding of the negative mask embeddings (Z_{neg}) 630 may include a vector that represents a visual image not associated with an object class. In some examples, each textual prompt of the textual prompts (Tₚₑᵣ) 620 may represent a textual label associated with a personalized object class. In one or more examples, the encoder (e.g., CLIP) may perform textual prompt tuning to train the textual prompts (Tₚₑᵣ) 620 based on personal concepts for the image. In some examples, determining the negative mask embeddings (Z_{neg}) 630 may include learning vocabulary other than the personal concepts (label smoothing over other vocabulary words).

A semantic segmentation model (e.g., the semantic segmentation model 530 of FIG. 5A) may determine mask proposals (M) 685 and a negative mask (M_{neg}) 650 for the image based on the feature map(s) generated by the encoder. In one or more examples, determining the negative mask (M_{neg}) 650 may include learning visual concepts other than the personal visual concepts representing regions of interest to a user. In some aspects, the negative mask (M_{neg}) 650 can be generated based on a binary-cross entropy loss with a one minus a ground truth (GT) mask. In one or more examples, the semantic segmentation model may be a pre-trained open-vocabulary semantic segmentation neural network model. In some examples, the pre-trained open-vocabulary semantic segmentation neural network model may be a SAN.

The semantic segmentation model (e.g., SAN) may determine a similarity map (S) 680 (with a negative segmentation loss function L_{z}^{neg} 641) between total mask embeddings and total textual embeddings. In one or more examples, the total mask embeddings may include the mask embeddings (Z) 675 and the negative mask embeddings (Z_{neg}) 630. In some examples, the total textual embeddings may include the textual embeddings (Tₒₚₑₙ) 670 and the textual prompts (Tₚₑᵣ) 620. The semantic segmentation model (e.g., SAN) may determine a final semantic map 695 including final semantic predictions for the image based on the similarity map (S) 680 (with a negative segmentation loss function L_{z}^{neg} 641) and total mask proposals (e.g., based on the multiplication, by a multiplier 690, of the similarity map (S) 680 and the total mask proposals). In one or more examples, the total mask proposals may include the mask proposals (M) 685 and the negative mask (M_{neg}) 650.

According to a mathematical explanation of the standard prediction process of open-vocabulary semantic segmentation models, the textual embeddings for open-vocabulary segmentation are Tϵ [symbol] ^{V×D}, where V and D refer to the open-vocabulary size and the feature dimension, respectively. The mask embeddings are Zϵ [symbol] ^{N×D}, where N indicates the number of masks. The similarity between words and masks can be computed by S=T·Z^{T}, where Sϵ [symbol] ^{V×N}. By using the similarity map S and the mask proposals

$$M ∈ {ℝ}^{\frac{H}{16} \times \frac{W}{16} \times N} ,$$

the final prediction output can then be obtained by P=M×S^{T}, where

$$H ∈ {ℝ}^{\frac{H}{16} \times \frac{W}{16} \times V} .$$

In one or more examples, the task of personalized open-vocabulary semantic segmentation aims to learn the personal concept (e.g., learning a textual embedding specified for the personal concept, such as text prompt tuning) as one straightforward approach. Performing textual prompt tuning has been shown to capture the personal concept better than without using textual prompt tuning (e.g., the frozen model for open-vocabulary semantic segmentation, which can be denoted as without personalization). However, simply performing textual prompt tuning without careful consideration can result in an increase in false positives. While updating the textual embedding for the personal concept, the model can become overconfident and erroneously recognize other concepts as the personal concept. Based on such an observation, negative mask embeddings and a negative mask can be employed to reduce the number of false positive predictions.

Referring to disclosed open-vocabulary semantic segmentation engine 610, which employs negative mask embeddings and a negative mask, assuming that text prompt tuning is performed, the original textual embeddings for open-vocabulary segmentation can be denoted as Tₒₚₑₙϵ [symbol] ^{V×D}. The learnable textual embeddings are Tₚₑᵣϵ [symbol] ^{1×D} which learns the personal concept. As such, the textual embeddings are T=[Tₒₚₑₙ; Tₚₑᵣ]. Regarding the mask embeddings, the original mask embeddings are Zϵ [symbol] ^{N×D} and the learnable weight is W_{Z} ϵR. A negative mask embedding can then be obtained by Z_{reg}ϵ [symbol] ^{1×D} by:

$${z}_{neg} = {w}_{z} {z}_{open} \qquad ( 1 )$$

The negative mask embedding Z_{neg} can be concatenated to Zₒₚₑₙ, which gives Z=[Zₒₚₑₙ; Z_{neg}], where Zϵ [symbol] ^{(N+1)×D}.

The similarity map can then be obtained by S=T·Z. A goal of the negative mask embedding Z_{neg} is to match M_{reg} to words other than the personal concept, in which case the negative mask embedding Z_{neg} can be supervised to learn other words equally, which can be formulated using S as:

$${ℒ}_{z}^{neg} = - {\sum }_{i = 1 , i \neq k}^{V} \frac{1}{V - 1} log S [ i , j ] \qquad ( 2 )$$

where j and k can indicate the index of negative mask embedding and learnable textual embedding, respectively.

Given original mask proposals

$${M}_{open} ∈ {ℝ}^{\frac{H}{16} \times \frac{W}{16} \times N} ,$$

a mask can be obtained by

$${M}_{neg} ∈ {ℝ}^{\frac{H}{16} \times \frac{W}{16} \times 1}$$

that learns visual concepts other than the personal concept, termed as a negative mask. With a learnable convolutional layer W_{M}, a negative mask can be obtained by:

$${M}_{neg} = {W}_{M} {M}_{open} \qquad ( 3 )$$

With the ground truth mask of personal concept M_{gt}, 1−M_{gt} can be utilized as the ground truth mask for the supervision of M_{neg}g using the binary cross-entropy loss, which can be formulated as:

$${ℒ}_{M}^{neg} = - ( 1 - {M}_{gt} ) log ( {M}_{neg} ) - {M}_{gt} log ( 1 - {M}_{neg} ) . \qquad ( 4 )$$

For the final mask proposal,

$$M = [ {M}_{open} ; {M}_{neg} ] ∈ {ℝ}^{\frac{H}{16} \times \frac{W}{16} \times ( N + 1 )} .$$

Since the method utilizes prompt tuning, the original segmentation loss function [symbol] _{seg} can also be used. As such, the total loss function can be formulated as:

$${ℒ}_{total} = {ℒ}_{seg} + {λ}_{z}^{neg} {ℒ}_{z}^{neg} + {λ}_{M}^{neg} {ℒ}_{M}^{neg} . \qquad ( 5 )$$

In one or more aspects, to improve the representation of textual embeddings, visual information can be added using a few images and masks. Incorporating visual embeddings into textual embeddings (e.g., textual prompts) is shown to enrich the information. In one or more examples personal visual concepts can be added to textual embeddings (e.g., textual prompts) for providing additional information.

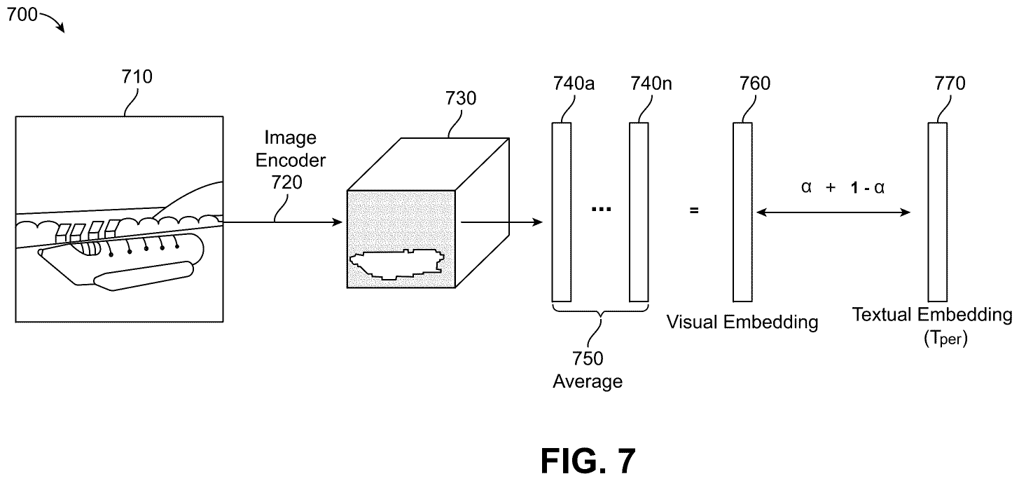

FIG. 7 is a diagram illustrating an example of a process 700 of using an additional visual embedding for tuning textual prompts (Tₚₑᵣ). In FIG. 7, during operation of the process 700, a pretrained image encoder 720 I_{enc} (e.g., a CLIP image encoder) can extract a feature map F=I_{enc}(X) (e.g., feature map 730) from a given image X (e.g., image 710). The image encoder 720 can select or determine feature embeddings 740a through 740n (e.g., each in the form of a vector) from the feature map 730 that correspond to the personal concepts using the masks. The feature embeddings 740a through 740n can be textual embeddings. The image encoder 720 can then average 750 the feature embeddings 740a through 740n to obtain a visual embedding 760 (e.g., in the form of a vector), such as a clip visual embedding. The average 750 of the feature embeddings 740a through 740n can be formulated as:

$${F}^{per} = \frac{1}{{\sum }_{j = 1}^{HW} 𝟙 ( M = 1 )} {\sum }_{i = 1}^{HW} F ∘ {M}_{gt} \qquad ( 6 )$$

where M indicates the mask interpolated to have the same resolution with F, and indicates an element-wise multiplication operation. When given multiple images, the F^{per} of multiple images can be averaged. The image encoder 720 can then obtain a textual embedding 770 (e.g., in the form of a vector) by combining the original textual embeddings, such as by performing a convex sum with the original textual embeddings, shown by

$${T}_{vis}^{per} = α \cdot {F}^{per} + ( 1 - α ) \cdot {T}^{per}$$

(e.g., textual embedding 770), which is the interpolation between the obtained visual embedding F^{per} and the personalized textual embedding T^{per}.

In one or more aspects, experiments for evaluation of open-vocabulary semantic segmentation models (e.g., the disclosed open-vocabulary semantic segmentation engine 610) can be performed by using commercially available datasets, such as FSS-1000, CUB-200, and ADE-20K. In one or more examples, for pretrained open-vocabulary semantic segmentation models, personalization of certain visual concepts can be performed by using any of these datasets. The classes included within these datasets used for evaluation can be assumed to be regarded as open-vocabulary words.

A model (e.g., the disclosed open-vocabulary semantic segmentation engine 610) may be evaluated depending on the number of images K used for personalization, which may be set for example as k=1,3,5. For the test sets, pairs of images, where each pair includes an image with the personal concept (e.g., a positive image) and an image without the personal concept (e.g., a negative image), can be included. The images without the personal concept (e.g., the negative images) are intentionally included in the test sets because the models that are finetuned to recognize the personal concepts may overconfidently also predict other concepts as the personal concepts. Preventing such behavior is one of the main goals. As such, the images without the personal concept (e.g., the negative images) are within the test sets. In one or more examples, 30 classes may be selected for FSS-1000 and ADE-20K, and 200 classes may be selected for CUB-200. Since the selected classes and evaluation settings are different from the original datasets, FSS-1000, CUB-200, and ADE-20K can be referred to as FSS^{per}, CUB^{per}, and ADE^{per}, respectively.

In one or more examples, the final semantic predictions may be evaluated based on one or more pairs of images (e.g., object class images). In one or more examples, each pair of images (e.g., object class images) may include a positive image associated with an object class and a negative image associated with the object class.

In one or more aspects, two different evaluation metrics using intersection over union (IoU) may be employed (e.g., IoU^{per} and mIoU). IoU^{per} evaluates how precisely a given segmentation model predicts the personal concept. Specifically, the regions of the personal concept are considered as the positive labels, while the regions of other classes are all negative labels. For mIoU, additional to IoU^{per}, the IoU of other classes is included, and the values of IoU are averaged. While ADE-20K originally includes the ground truth labels for open-vocabulary classes, the labels can be used for evaluating mIoU in ADE^{per}. However, FSS-1000 and CUB-200 do not include the ground truth labels for open-vocabulary classes and, as such, the predictions of pretrained open-vocabulary segmentation models can be assumed to be the ground truth labels, and mIoU for FSS^{per} and CUB^{per} can be computed. The main goal is to improve IoU^{per}, while maintaining a reasonable level of performance on mIoU.

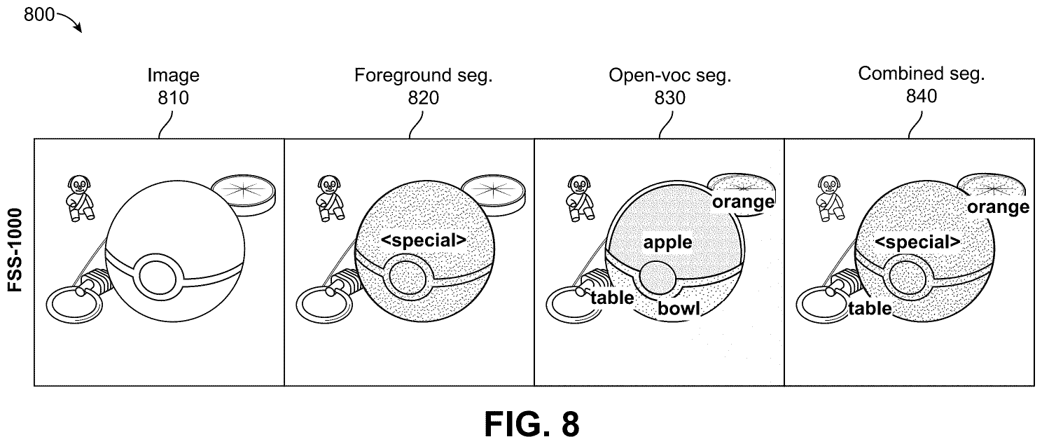

FIG. 8 shows an example of determining (e.g., producing) a segmentation mask that may be utilized as a ground truth for datasets (e.g., FSS-1000 and CUB-200). In particular, FIG. 8 is a diagram illustrating an example 800 of determining a segmentation mask that may be utilized as a ground truth for evaluation. In FIG. 8, an example of an image 810 from the FSS-1000 dataset is shown. FIG. 8 also shows an example of an original ground truth (e.g., foreground mask 820) of the FSS-1000 dataset. In FIG. 8, a predicted open-vocabulary segmentation mask 830 is shown. The foreground mask 820 can be overlaid on the predicted open-vocabulary segmentation mask 830 to obtain a combined segmentation mask 840, which may be utilized as a ground truth (e.g., for FSS-1000).

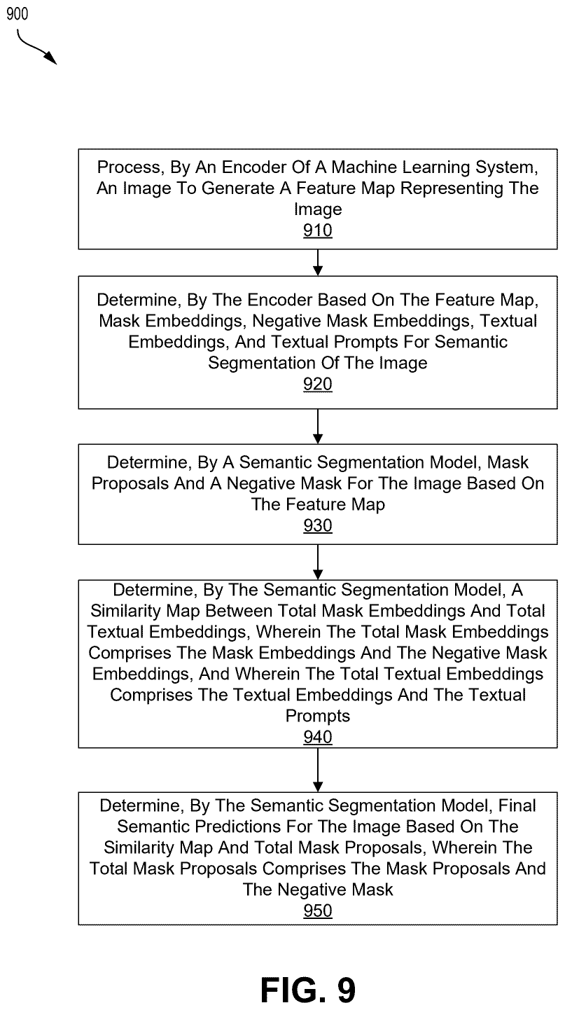

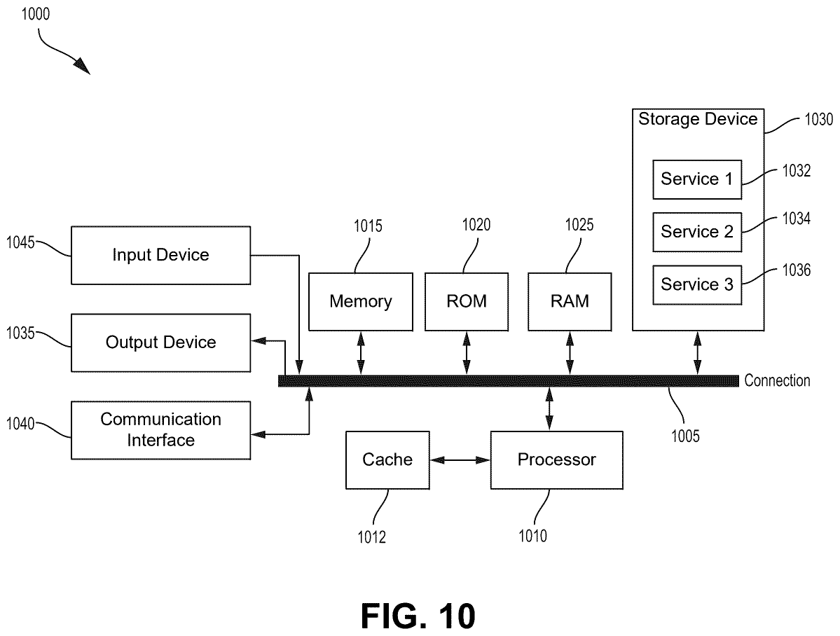

FIG. 9 is a flow chart illustrating an example of a process 900 for personalized open-vocabulary semantic segmentation for images. The process 900 may be performed by a computing device or apparatus or a component or system (e.g., one or more chipsets, one or more processors such as one or more CPUs, DSPs, NPUs, NSPs, microcontrollers, ASICs, FPGAs, programmable logic devices, discrete gates or transistor logic components, discrete hardware components, etc., an ML system such as a neural network model which can include transformer 100, semantic segmentation engine 541, open-vocabulary semantic segmentation engine 610 of FIGS. 1, 5, and 6, etc., any combination thereof, and/or other component or system) of the computing device or apparatus. The computing device or apparatus may be a vehicle or component or system of a vehicle, a mobile device (e.g., a mobile phone), a network-connected wearable such as a watch, an extended reality (XR) device (e.g., a virtual reality (VR) device, augmented reality (AR) device, and/or mixed reality (MR) device), or other type of computing device. In some cases, the computing device or apparatus can be a system on a chip (SOC), the computing system 1000 of FIG. 10, and/or other computing device or apparatus.

At block 910, the computing device (or component thereof) can process, using an encoder of a machine learning system, an image to generate a feature map representing the image. In some aspects, the encoder can include a pre-trained neural network image encoder, such as a contrastive language-image pre-training (CLIP) model.

At block 920, the computing device (or component thereof) can determine, using the encoder based on the feature map, mask embeddings, negative mask embeddings, textual embeddings, and textual prompts for semantic segmentation of the image. In some cases, each textual embedding of the textual embeddings includes a vector that represents a textual label associated with an object class. In some aspects, each mask embedding of the mask embeddings includes a vector that represents a visual image associated with an object class. In some examples, each negative mask embedding of the negative mask embeddings includes a vector that represents a visual image not associated with an object class. In some aspects, to determine the negative mask embeddings, the computing device (or component thereof) can learn vocabulary other than personal concepts (e.g., user-specific text, such as one or more textual prompts from a user). In some cases, each textual prompt of the textual prompts represents a textual label associated with a personalized object class.

At block 930, the computing device (or component thereof) can determine, using a semantic segmentation model, mask proposals and a negative mask for the image based on the feature map. In some aspects, semantic segmentation model is a pre-trained open-vocabulary semantic segmentation neural network model (e.g., the side adapter network (SAN) described herein). In some cases, to determine the negative mask, the computing device (or component thereof) can learn visual concepts other than personal visual concepts (e.g., user-specified objects, such as objects associated with a user-specific textual prompt).

At block 940, the computing device (or component thereof) can determine, using the semantic segmentation model, a similarity map between total mask embeddings and total textual embeddings. The total mask embeddings include the mask embeddings and the negative mask embeddings. The total textual embeddings include the textual embeddings and the textual prompts.

At block 950, the computing device (or component thereof) can determine, using the semantic segmentation model, final semantic predictions for the image based on the similarity map and total mask proposals. The total mask proposals include the mask proposals and the negative mask. In some aspects, the computing device (or component thereof) can evaluate the final semantic predictions based on one or more pairs of object class images. For example, each pair of object class images can include a positive image associated with an object class and a negative image associated with the object class.

In some aspects, the computing device (or component thereof) can perform, using the encoder, textual prompt tuning to train the textual prompts based on personal concepts for the image. In some cases, the computing device (or component thereof) can determine the textual prompts based on an additional visual embedding. In some examples, the computing device (or component thereof) can determine the textual prompts further based on a combination of the additional visual embedding and an average of the textual embeddings. For instance, the combination can include a convex sum of the additional visual embedding with an average of the textual embeddings.

In some cases, the computing device configured to perform the process 900 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 900 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 900 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 900 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 10 is a block diagram illustrating an example of a computing system 1000, which may be employed for personalized open-vocabular semantic segmentation for images. In particular, FIG. 10 illustrates an example of computing system 1000, which can be for example any computing device making up internal computing system, a remote computing system, a camera, or any component thereof in which the components of the system are in communication with each other using connection 1005. Connection 1005 can be a physical connection using a bus, or a direct connection into processor 1010, such as in a chipset architecture. Connection 1005 can also be a virtual connection, networked connection, or logical connection.

In some aspects, computing system 1000 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1000 includes at least one processing unit (CPU or processor) 1010 and connection 1005 that communicatively couples various system components including system memory 1015, such as read-only memory (ROM) 1020 and random access memory (RAM) 1025 to processor 1010. Computing system 1000 can include a cache 1012 of high-speed memory connected directly with, in close proximity to, or integrated as part of processor 1010.

Processor 1010 can include any general purpose processor and a hardware service or software service, such as services 1032, 1034, and 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which can represent any number of input mechanisms, such as a microphone for speech, a touch-sensitive screen for gesture or graphical input, keyboard, mouse, motion input, speech, etc. Computing system 1000 can also include output device 1035, which can be one or more of a number of output mechanisms. In some instances, multimodal systems can enable a user to provide multiple types of input/output to communicate with computing system 1000.

Computing system 1000 can include communications interface 1040, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1040 may also include one or more range sensors (e.g., LiDAR sensors, laser range finders, RF radars, ultrasonic sensors, and infrared (IR) sensors) configured to collect data and provide measurements to processor 1010, whereby processor 1010 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1030 can include software services, servers, services, etc., that when the code that defines such software is executed by the processor 1010, it causes the system to perform a function. In some aspects, a hardware service that performs a particular function can include the software component stored in a computer-readable medium in connection with the necessary hardware components, such as processor 1010, connection 1005, output device 1035, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the aspects disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus for image processing, the apparatus comprising: at least one memory; and at least one processor coupled to the at least one memory and configured to: process, using an encoder of a machine learning system, an image to generate a feature map representing the image; determine, using the encoder based on the feature map, mask embeddings, negative mask embeddings, textual embeddings, and textual prompts for semantic segmentation of the image; determine, using a semantic segmentation model, mask proposals and a negative mask for the image based on the feature map; determine, using the semantic segmentation model, a similarity map between total mask embeddings and total textual embeddings, wherein the total mask embeddings comprise the mask embeddings and the negative mask embeddings, and wherein the total textual embeddings comprise the textual embeddings and the textual prompts; and determine, using the semantic segmentation model, final semantic predictions for the image based on the similarity map and total mask proposals, wherein the total mask proposals comprise the mask proposals and the negative mask.

Aspect 2. The apparatus of Aspect 1, wherein the at least one processor is configured to perform, using the encoder, textual prompt tuning to train the textual prompts based on personal concepts for the image.

Aspect 3. The apparatus of Aspect 2, wherein the at least one processor is configured to determine the textual prompts based on an additional visual embedding.

Aspect 4. The apparatus of Aspect 3, wherein the at least one processor is configured to determine the textual prompts further based on a combination of the additional visual embedding and an average of the textual embeddings.

Aspect 5. The apparatus of Aspect 4, wherein the combination comprises a convex sum of the additional visual embedding with an average of the textual embeddings.

Aspect 6. The apparatus of any of Aspects 1 to 5, wherein, to determine the negative mask embeddings, the at least one processor is configured to learn vocabulary other than personal concepts.

Aspect 7. The apparatus of any of Aspects 1 to 6, wherein, to determine the negative mask, the at least one processor is configured to learn visual concepts other than personal visual concepts.

Aspect 8. The apparatus of any of Aspects 1 to 7, wherein the at least one processor is configured to evaluate the final semantic predictions based on one or more pairs of object class images, wherein each pair of object class images comprises a positive image associated with an object class and a negative image associated with the object class.

Aspect 9. The apparatus of any of Aspects 1 to 8, wherein the encoder is a pre-trained neural network image encoder.

Aspect 10. The apparatus of Aspect 9, wherein the pre-trained neural network image encoder is a contrastive language-image pre-training (CLIP) model.

Aspect 11. The apparatus of any of Aspects 1 to 10, wherein the semantic segmentation model is a pre-trained open-vocabulary semantic segmentation neural network model.

Aspect 12. The apparatus of Aspect 11, wherein the pre-trained open-vocabulary semantic segmentation neural network model is a side adapter network (SAN).

Aspect 13. The apparatus of any of Aspects 1 to 12, wherein each textual embedding of the textual embeddings comprises a vector that represents a textual label associated with an object class.

Aspect 14. The apparatus of any of Aspects 1 to 13, wherein each mask embedding of the mask embeddings comprises a vector that represents a visual image associated with an object class.

Aspect 15. The apparatus of any of Aspects 1 to 14, wherein each negative mask embedding of the negative mask embeddings comprises a vector that represents a visual image not associated with an object class.

Aspect 16. The apparatus of any of Aspects 1 to 15, wherein each textual prompt of the textual prompts represents a textual label associated with a personalized object class.

Aspect 17. A method of image processing, the method comprising: processing, by an encoder of a machine learning system, an image to generate a feature map representing the image; determining, by the encoder based on the feature map, mask embeddings, negative mask embeddings, textual embeddings, and textual prompts for semantic segmentation of the image; determining, by a semantic segmentation model, mask proposals and a negative mask for the image based on the feature map; determining, by the semantic segmentation model, a similarity map between total mask embeddings and total textual embeddings, wherein the total mask embeddings comprise the mask embeddings and the negative mask embeddings, and wherein the total textual embeddings comprise the textual embeddings and the textual prompts; and determining, by the semantic segmentation model, final semantic predictions for the image based on the similarity map and total mask proposals, wherein the total mask proposals comprise the mask proposals and the negative mask.

Aspect 18. The method of Aspect 17, further comprising performing, by the encoder, textual prompt tuning to train the textual prompts based on personal concepts for the image.

Aspect 19. The method of Aspect 18, wherein determining the textual prompts is based on an additional visual embedding.

Aspect 20. The method of Aspect 19, wherein determining the textual prompts is further based on a combination of the additional visual embedding and an average of the textual embeddings.

Aspect 21. The method of Aspect 20, wherein the combination comprises a convex sum of the additional visual embedding with an average of the textual embeddings.

Aspect 22. The method of any of Aspects 17 to 21, wherein determining the negative mask embeddings comprises learning vocabulary other than personal concepts.

Aspect 23. The method of any of Aspects 17 to 22, wherein determining the negative mask comprises learning visual concepts other than personal visual concepts.

Aspect 24. The method of any of Aspects 17 to 23, further comprising evaluating the final semantic predictions based on one or more pairs of object class images, wherein each pair of object class images comprises a positive image associated with an object class and a negative image associated with the object class.

Aspect 25. The method of any of Aspects 17 to 24, wherein the encoder is a pre-trained neural network image encoder.

Aspect 26. The method of Aspect 25, wherein the pre-trained neural network image encoder is a contrastive language-image pre-training (CLIP) model.

Aspect 27. The method of any of Aspects 17 to 26, wherein the semantic segmentation model is a pre-trained open-vocabulary semantic segmentation neural network model.

Aspect 28. The method of Aspect 27, wherein the pre-trained open-vocabulary semantic segmentation neural network model is a side adapter network (SAN).

Aspect 29. The method of any of Aspects 17 to 28, wherein each textual embedding of the textual embeddings comprises a vector that represents a textual label associated with an object class.

Aspect 30. The method of any of Aspects 17 to 29, wherein each mask embedding of the mask embeddings comprises a vector that represents a visual image associated with an object class.

Aspect 31. The method of any of Aspects 17 to 30, wherein each negative mask embedding of the negative mask embeddings comprises a vector that represents a visual image not associated with an object class.

Aspect 32. The method of any of Aspects 17 to 31, wherein each textual prompt of the textual prompts represents a textual label associated with a personalized object class.

Aspect 33. A non-transitory computer-readable medium having stored thereon instructions that, when executed by one or more processors, cause the one or more processors to perform operations according to any of Aspects 17 to 32.

Aspect 34. An apparatus of image processing, the apparatus comprising one or more means for performing operations according to any of Aspects 17 to 32.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for image processing, the apparatus comprising:
at least one memory; and
at least one processor coupled to the at least one memory and configured to:
process, using an encoder of a machine learning system, an image to generate a feature map representing the image;
determine, using the encoder based on the feature map, mask embeddings, negative mask embeddings, textual embeddings, and textual prompts for semantic segmentation of the image;
determine, using a semantic segmentation model, mask proposals and a negative mask for the image based on the feature map;
determine, using the semantic segmentation model, a similarity map between total mask embeddings and total textual embeddings, wherein the total mask embeddings comprise the mask embeddings and the negative mask embeddings, and wherein the total textual embeddings comprise the textual embeddings and the textual prompts; and
determine, using the semantic segmentation model, final semantic predictions for the image based on the similarity map and total mask proposals, wherein the total mask proposals comprise the mask proposals and the negative mask.

2. The apparatus of claim 1, wherein the at least one processor is configured to perform, using the encoder, textual prompt tuning to train the textual prompts based on personal concepts for the image.

3. The apparatus of claim 2, wherein the at least one processor is configured to determine the textual prompts based on an additional visual embedding.

4. The apparatus of claim 3, wherein the at least one processor is configured to determine the textual prompts further based on a combination of the additional visual embedding and an average of the textual embeddings.

5. The apparatus of claim 4, wherein the combination comprises a convex sum of the additional visual embedding with an average of the textual embeddings.

6. The apparatus of claim 1, wherein, to determine the negative mask embeddings, the at least one processor is configured to learn vocabulary other than personal concepts.

7. The apparatus of claim 1, wherein, to determine the negative mask, the at least one processor is configured to learn visual concepts other than personal visual concepts.

8. The apparatus of claim 1, wherein the at least one processor is configured to evaluate the final semantic predictions based on one or more pairs of object class images, wherein each pair of object class images comprises a positive image associated with an object class and a negative image associated with the object class.

9. The apparatus of claim 1, wherein the encoder is a pre-trained neural network image encoder.

10. The apparatus of claim 9, wherein the pre-trained neural network image encoder is a contrastive language-image pre-training (CLIP) model.

11. The apparatus of claim 1, wherein the semantic segmentation model is a pre-trained open-vocabulary semantic segmentation neural network model.

12. The apparatus of claim 11, wherein the pre-trained open-vocabulary semantic segmentation neural network model is a side adapter network (SAN).

13. The apparatus of claim 1, wherein each textual embedding of the textual embeddings comprises a vector that represents a textual label associated with an object class.

14. The apparatus of claim 1, wherein each mask embedding of the mask embeddings comprises a vector that represents a visual image associated with an object class.

15. The apparatus of claim 1, wherein each negative mask embedding of the negative mask embeddings comprises a vector that represents a visual image not associated with an object class.

16. The apparatus of claim 1, wherein each textual prompt of the textual prompts represents a textual label associated with a personalized object class.

17. A method of image processing, the method comprising:
processing, by an encoder of a machine learning system, an image to generate a feature map representing the image;
determining, by the encoder based on the feature map, mask embeddings, negative mask embeddings, textual embeddings, and textual prompts for semantic segmentation of the image;
determining, by a semantic segmentation model, mask proposals and a negative mask for the image based on the feature map;
determining, by the semantic segmentation model, a similarity map between total mask embeddings and total textual embeddings, wherein the total mask embeddings comprise the mask embeddings and the negative mask embeddings, and wherein the total textual embeddings comprise the textual embeddings and the textual prompts; and
determining, by the semantic segmentation model, final semantic predictions for the image based on the similarity map and total mask proposals, wherein the total mask proposals comprise the mask proposals and the negative mask.

18. The method of claim 17, further comprising performing, by the encoder, textual prompt tuning to train the textual prompts based on personal concepts for the image.

19. The method of claim 18, wherein determining the textual prompts is based on an additional visual embedding.

20. The method of claim 19, wherein determining the textual prompts is further based on a combination of the additional visual embedding and an average of the textual embeddings.
